(19) United States
(12) Patent Application Publication
(10) Pub. No.: US 2021/0015078 A1
(43) Pub. Date: Jan. 21, 2021

(54) SLIDING DOUBLE HANDLE LEASH

(71) Applicant: Daniel Bray, Vancouver, WA (US)

(72) Inventor: Daniel Bray, Vancouver, WA (US)

(21) Appl. No.: 16/513,600

(22) Filed: Jul. 16, 2019

(51) Int. Cl. A01K 27/00

(52) U.S. Cl. CPC A01K 27/004; A01K 27/001

(57) ABSTRACT

Leash assemblies for use in leading and controlling dogs and/or other animals, and associated systems and methods, are disclosed herein. In one embodiment, a leash assembly includes a connection member configured to be coupled to a harness or collar worn by an animal. A lead line is slidably coupled to the connection member and can include a first loop and a second loop configured to be grasped by a handler. A first stop member is coupled to the first loop and a second stop member is coupled to the second loop. The stop members are sized and shaped to prevent the first and second loops from sliding entirely through the connection member. This arrangement permits the handler to lead the animal by grasping the first loop, the second loop, or each of the first and second loops.

### TECHNICAL FIELD

The present disclosure is generally directed to leash assemblies for use in controlling and leading animals.

### BACKGROUND

Conventional animal leash assemblies typically include a leash or lead line having a handle (e.g., a loop, retractor, handle etc.) at one end and a hook permanently attached to the opposite end. During use, the hook can be releasably attached to a harness or collar worn by an animal, such as a dog.

One downside with such conventional leash assemblies is that the lead line can easily tangle or snag as the animal weaves around trees, poles, furniture legs, or other obstacles. Typically, when the lead line is tangled, the handler must release their grip on the handle or lead line and awkwardly bend down to untangle the lead line. Not only is untangling the lead line cumbersome, but releasing the lead line gives the animal an opportunity to escape the handler's control.

Another limitation with such conventional leash assemblies is that it can be difficult or impossible to remove the individual components of the leash assembly for replacement, maintenance, cleaning, etc. For example, if the hook breaks or the animal chews through the lead line, typically the entire leash assembly must be discarded. Likewise, the hook and/or other components of the leash assembly may damage the interior of a washing machine if placed in the machine for cleaning, which encourages users to discard soiled—but still functional—leash assemblies rather than cleaning them.

### BRIEF DESCRIPTION OF THE DRAWINGS

FIG. 1A is a side view of a leash assembly configured in accordance with an embodiment of the present technology.

FIG. 1B is an isometric view of a connection member of the leash assembly of FIG. 1 configured in accordance with an embodiment of the present technology.

FIGS. 2A-2C are side views of the leash assembly of FIG. 1 coupled to an animal restraint and in a first position, a second position, and a third position, respectively, in accordance with embodiments of the present technology.

FIGS. 3A and 3B are front and bottom views, respectively, of a stop member for use with the leash assembly of FIG. 1, configured in accordance with an embodiment of the present technology.

FIG. 4 is an enlarged isometric view of the leash assembly of FIG. 1 with the stop member of FIGS. 3A and 3B installed thereon in accordance with an embodiment of the present technology.

### DETAILED DESCRIPTION

The following disclosure describes various embodiments of leash assemblies for use in leading and controlling animals. In some embodiments, a leash assembly includes a lead line slidably coupled to a connection member configured to be coupled to a harness, collar, or other restraint worn by an animal. The lead line can include a first loop forming a first end region of the lead line and a second loop forming a second end region of the lead line. A first stop member is coupled to the first loop and a second stop member is coupled to the second loop. The first and second stop members are sized and shaped to prevent the first and second loops, respectively, from sliding entirely through and disengaging the connection member.

In one aspect of the present technology, when the connection member is coupled to an animal collar or animal harness, a handler can grasp one of the first or second loops to lead and control the animal while the other one of the first or second loops is pulled partially through the connection member and prevented from sliding entirely therethrough by the corresponding stop member. For example, when the user grasps the first loop and the lead line is pulled taut (by, e.g., the movements of the animal and/or the handler), the second stop member is pulled against the connection member to prevent the second loop from sliding entirely therethrough. By this arrangement, if the lead line becomes tangled around any obstacles—for example, as the animal steps over the lead line, circles a tree or sign, weaves under patio furniture, etc.—the handler can simply grasp the second stop member and/or the second loop and release the first loop. This permits the lead line to slide through the connection member and untangle as the first loop moves toward the connection member and back around any obstacles tangling or snagging the lead line. Moreover, control over the animal is maintained as the handler can always grasp the first loop and/or the second loop while switching their grasp to untangle the lead line. In contrast, with conventional leash assemblies the handler must frequently drop the lead line or cumbersomely exchange it between hands to untangle the lead line—possibly allowing the animal to escape their control.

In another aspect of the present technology, the leash assembly can be easily disassembled for cleaning and/or for replacing or upgrading the various components. For example, in some embodiments the stop members can be removed (e.g., slid off) from the lead line and the lead line can be pulled entirely through the connection member so that the lead line can be washed in a washing machine without the risk of the stop members or the connection member damaging the washing machine. Similarly, the lead line can be easily replaced, such as with a lead line made from a more durable material, having a different length, having different aesthetic characteristics (e.g., color), etc.

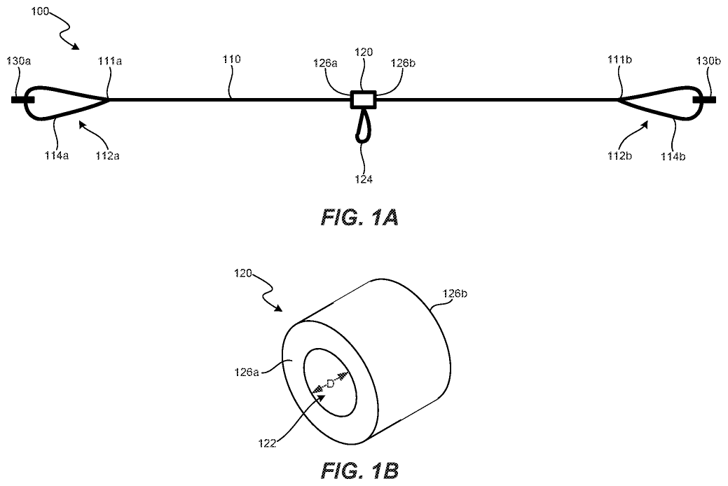

Certain details are set forth in the following description and in FIGS. 1-4 to provide a thorough understanding of various embodiments of the present technology. In other instances, well-known structures, materials, operations and/or systems often associated with animal leashes are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The terminology used below is to be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention.

Many of the details, dimensions, angles and other features shown in the Figures are merely illustrative of particular embodiments of the disclosure. Accordingly, other embodiments can have other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 is a side view of a leash assembly 100 configured in accordance with an embodiment of the present technology. In the illustrated embodiment, the leash assembly 100 includes a leash (or lead line) 110 slidably coupled to a connection member 120. FIG. 1B is an isometric view of the connection member 120. Referring to FIGS. 1A and 1B together, in the illustrated embodiment the connection member 120 defines a channel or opening 122 having a generally circular cross-sectional shape, and the lead line 110 extends through and is slidably positioned within the opening 122. In other embodiments, the opening 122 can have an oval, rectilinear, polygonal, irregular, or other cross-sectional shape. In some embodiments, the connection member 120 is a ring, hollow tubular member, etc., while in other embodiments the connection member 120 can include one or more pulleys, rollers, and/or other components configured to securely receive the lead line 110 while also allowing the lead line 110 to slide therethrough. In the illustrated embodiment, a connector 124 (e.g., a hook, clip, ring, carabiner, etc.) is connected to the connection member 120 and is configured to be releasably coupled to a collar, harness, or other restraint worn by an animal (“an animal restraint”). In some embodiments, the connector 124 is rotatably coupled to the connection member 120 such that the connection member 120 can rotate relative to the connector 124 when an animal secured within the animal restraint changes position relative to a handler grasping the lead line 110 (e.g., grasping one or both of the loops 114a, b). The connection member 120 and the connector 124 can be formed from metal, plastic, and/or other materials strong enough to withstand the forces imparted thereon as the handler leads and controls the animal with the leash assembly 100.

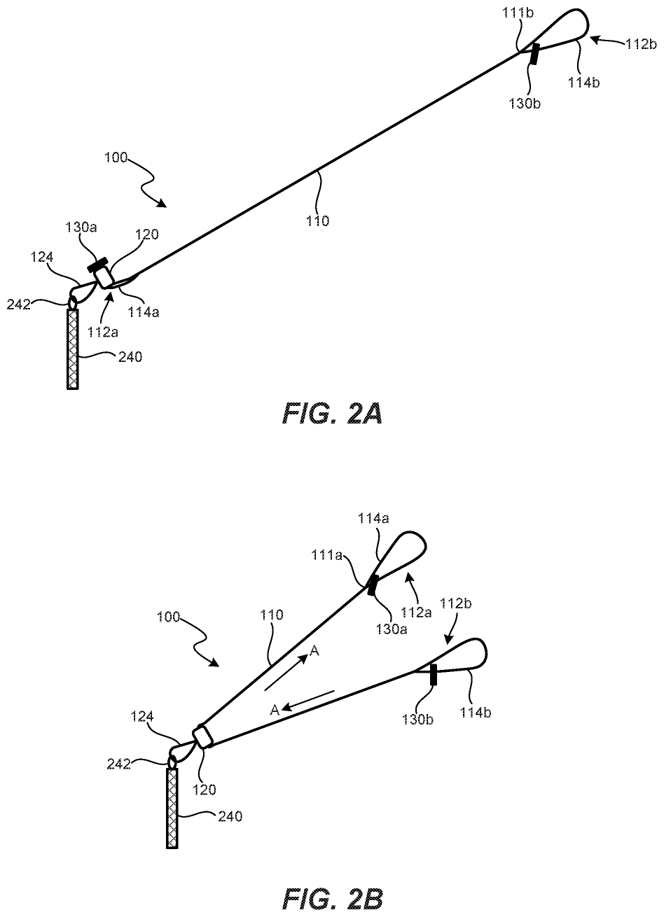

The lead line 110 includes a first end region or portion 112a and a second end region or portion 112b opposite the first end region 112a. In the illustrated embodiment, the lead line 110 is attached to itself (i) at a first connection region 111a to form a first loop 114a at the first end region 112a, and (ii) at a second connection region 111b to form a second loop 114b at the second end region 112b. As described in greater detail below with reference to FIGS. 2A-2C, the handler can grasp one or both of the loops 114a, b during use of the leash assembly 100 to lead and control the animal. In other embodiments, the loops 114a, b can be omitted and/or one or more handles (e.g., plastic or metal loops), grips, or other components can be secured to the end regions 112a, b of the lead line 110 to enable the handler to comfortably and securely maintain control of the lead line 110 and the animal. In some such embodiments, the handles, grips, etc., can be removably coupled to the lead line 110 such that leash assembly 100 can be easily disassembled for cleaning, maintenance, etc. The lead line 110 can be made of any suitably strong and flexible material, such as one or more of: ribbon, nylon, woven webbing strips, leather strips, rope, cord, chain, etc.

In the illustrated embodiment a first stop member 130a is coupled (e.g., slidably coupled) to the first loop 114a and a second stop member 130b is coupled (e.g. slidably coupled) to the second loop 114b. The first stop member 130a is configured (e.g., sized and shaped) to prevent the first end region 112a of the lead line 110 from sliding entirely through the opening 122 of the connection member 120, and the second stop member 130b is configured to prevent the second end region 112b of the lead line 110 from sliding entirely through the opening 122 of the connection member 120. For example, the opening 122 of the connection member 120 can have a cross-sectional dimension D (e.g., a maximum dimension/diameter) as shown in FIG. 1B, and the stop members 130a, b can each have at least one dimension (e.g., a minimum dimension) that is greater than the dimension D of the opening 122. Thus, the first stop member 130a can engage (e.g., be pulled against, contact, abut, etc.) the connection member 120 when the second end region 112b of the lead line 110 is pulled away from the connection member 120 to prevent the first end region 112a from being pulled through the connection member 120—which would free the animal from the handler's control. Likewise, the second stop member 130b can engage (e.g., be pulled against) the connection member 120 when the first end region 112a of the lead line 110 is pulled away from the connection member 120 to prevent the second end region 112b from being pulled through the connection member 120. More specifically, in some embodiments the first stop member 130a can be pulled against and engage a first end portion or perimeter 126a of the connection member 120 and the second stop member 130b can be pulled against and engage a second end portion or perimeter 126b of the connection member 120.

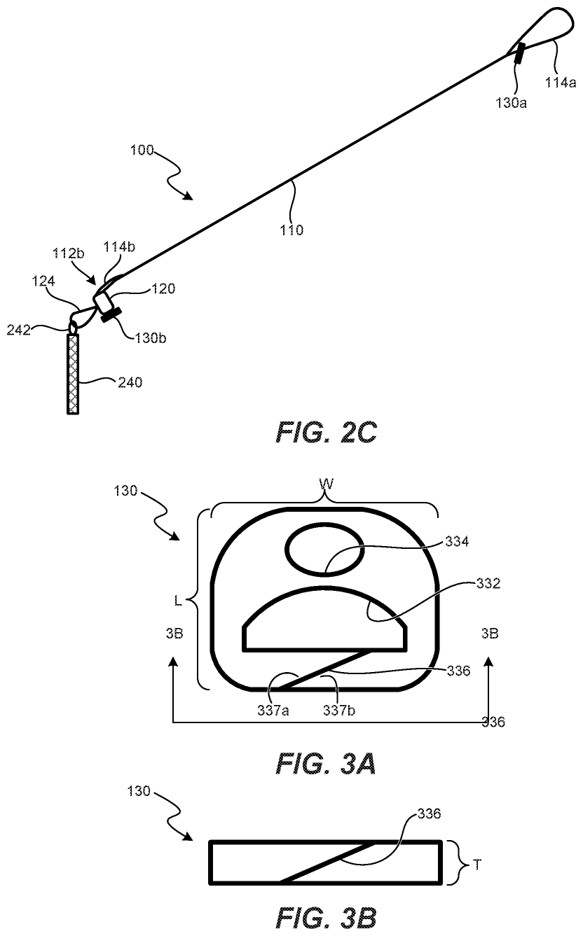

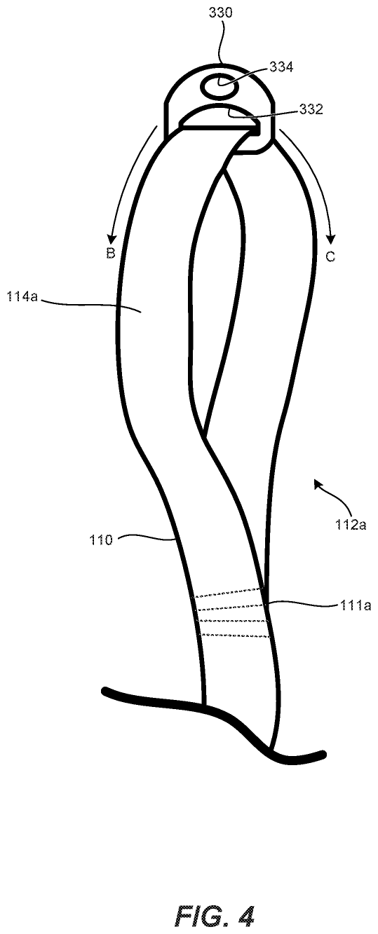

As described in greater detail below with reference to FIGS. 3A-4, in some embodiments the stop members 130 can be metal or plastic D-rings. In other embodiments, the stop members 130 can be snap hooks, carabiners, metal or plastic loops, etc. In yet other embodiments, the stop members 130a, b can be omitted and the loops 114a, b can be configured (e.g., sized and shaped) to prevent the end regions 112a, b, respectively, of the lead line 110 from sliding entirely through the connection member 120. That is, the loops 114a, b can have at least one dimension (e.g., a minimum dimension) that is greater than the dimension D of the opening 122 and can function as the stop members of the leash assembly 100. In some such embodiments, the connection regions 111a, b of the lead line 110 can have a dimension (e.g., thickness) that is greater than the dimension D of the opening 122.

FIGS. 2A-2C are side views of the leash assembly 100 coupled to an animal restraint 240 (e.g., a collar) and in a first position, a second position, and a third position, respectively, in accordance with embodiments of the present technology. Referring first to FIG. 2A, the connector 124 of the leash assembly 100 is releasably coupled to a loop 242 or other component of the animal restraint 240 to secure the leash assembly 100 to the animal restraint 240 and thus to an animal (not shown), such as a dog, wearing the animal restraint 240.

In the first position, the handler (not shown) can grasp the second loop 114b of the lead line 110 to lead and control the animal. In this position, the first stop member 130a is pulled against and engages the connection member 120 to prevent the first end region 112a of the lead line 110 from sliding entirely through the opening 122 (FIG. 1B) of the connection member 120 and disengaging the connection member 120 (e.g., such that lead line 110 would no longer be coupled to the animal restraint 240). In the illustrated embodiment, the first loop 114a is configured (e.g., sized and shaped) to extend at least partially through the opening 122 (FIG. 1B) of the connection member 120 in the first position. That is, the first loop 114a can be narrow enough to be pulled partially into/through the opening 122 of the connection member 120 in the first position. In one aspect of the present technology, this arrangement can prevent the first stop member 130a and the first loop 114a from contacting—and possibly distracting—the animal. In other embodiments, the first loop 114a can be sized and shaped such that it does not extend through the opening 122 of the connection member 120 in the first position. As described above, in some such embodiments the first stop member 130a can be omitted and the first loop 114a can be configured to stop the first end region 112a of the lead line 110 from sliding entirely through the opening 122 and disengaging the connection member 120. That is, the first loop 114a can be larger than the opening 122.

As further shown in FIG. 2A, in some embodiments the second stop member 130b is slidably coupled to the second loop 114b such that the second stop member 130b can be manually (by, e.g., the handler) or automatically moved (by, e.g., gravity) out of the way of the handler's hand when the handler grasps the second loop 114b of the lead line 110. That is, for example, the second stop member 130b can move toward and rest near the second connection region 111b to allow the handler to comfortably grasp the material of the lead line 110 without interference from the second stop member 130b.

Referring next to FIG. 2B, in the second position, the lead line 110 extends through the opening 122 (FIG. 1) of the connection member 120 (e.g., near a midpoint thereof) such that each of the loops 114a, b are positioned away from the connection member 120 and can be grasped by the handler. In one aspect of the present technology, the handler can grasp both of the loops 114a, b in different hands for maximum control over the animal. Alternatively, the handler can grasp both of the loops 114a, b in the same hand to effectively halve the length of the lead line 110 relative to the first position of FIG. 2A. In the illustrated embodiment, the first stop member 130a is similarly configured to move toward and rest near the first connection region 111a to allow the handler to comfortably grasp the material of the lead line 110 without interference from the first stop member 130a.

To transition from the first position shown in FIG. 2A to the second position shown in FIG. 2B, the handler can grasp and pull the first stop member 130a and/or the first loop 114a away from the connection member 120 (as shown FIG. 2A) while simultaneously allowing the second end region 112b of the lead line 110 to move toward the connection member 120. This movement is indicated by arrows A in FIG. 2B. In one aspect of the present technology, the handler can transition between the first and second positions without releasing their grasp on the leash assembly 100 (e.g., on the second loop 114b) and potentially allowing the animal to escape their control.

Referring to FIG. 2C, the third position is generally similar to but opposite of the first position, as the handler can grasp the first loop 114a (rather than the second loop 114b) of the lead line 110 to lead and control the animal. In the third position, the second stop member 130b is pulled against and engages the connection member 120 to prevent the second end region 112b of the lead line 110 from sliding entirely through the opening 122 (FIG. 1B) in the connection member 120 and disengaging the connection member 120. In the illustrated embodiment, the second loop 114b is configured (e.g., sized and shaped) to extend at least partially through the opening 122 (FIG. 1) of the connection member 120 in the third position. That is, the second loop 114b can be narrow enough to fit through the opening 122 in the connection member 120. In other embodiments, the second loop 114b can be sized and shaped such that it does not extend through the opening 122 of the connection member 120 in the third position. To transition from the second position to the third position, the handler need only release their grasp on the second loop 114b while maintaining their grasp on the first loop 114a. This allows the second end region 112b of the lead line 110 to move toward the connection member 120 as the animal and the handler move relative to one another, thereby increasing the tension in the lead line 110.

Often, the lead line 110 may become tangled/snagged as the animal (e.g., dog) weaves around various obstacles such as trees, posts, signs, bushes, furniture, etc. Referring to FIGS. 2A-2C together, in one aspect of the present of the technology, embodiments of the leash assembly 100 facilitate easy untangling of the lead line 110. For example, when the lead line 110 becomes tangled, the handler need only move the leash assembly 100 between the first position (FIG. 2A) and the third position (FIG. 2C), or from the second position (FIG. 2B) to the first position or third positions, to untangle the lead line 110. For example, when the lead line 110 becomes tangled in the first position (FIG. 2A), the handler can (I) grasp the first stop member 130a and/or the first loop 114a, (ii) release their grasp on the second loop 114b, and (iii) pull the first stop member 130a and/or the first loop 114a (or wait for the animal to move away from them), as this will draw the lead line 110 through the connection member 120 to the third position. Specifically, this movement pulls (e.g., retracts, draws, backs) the second end region 112b of the lead line 110 around the obstacles to untangle the lead line 110. In one aspect of the present technology, the leash assembly 100 allows the handler to untangle the lead line 110 without ever having to entirely release their grasp on the lead line 110—and thus without ever having to release their control over the animal. In contrast, untangling a conventional leash assembly typically requires the handler to temporarily release the lead line.

FIGS. 3A and 3B are front and bottom views, respectively, of the stop member 130 (i.e., either the first stop member 130a or the second stop member 130b) configured in accordance with an embodiment of the present technology. The stop member 130 can be installed onto the lead line 110 of the leash assembly 100 (FIG. 1) and prevent the lead line 110 from sliding entirely through the connection member 120, as described in detail above. FIG. 4 is an enlarged perspective view of the first end region 112a of the lead line 110 with the stop member 130 coupled thereto.

Referring to FIGS. 3A-4 together, in the illustrated embodiment the stop member 130 is a D-ring (e.g., a two-slot D-ring) having (i) a first opening 332 configured to slidably receive the lead line 110 (e.g., a portion of the first loop 114a) and (ii) a second opening 334 configured to receive and secure optional accessories (not shown; e.g., bells, ornamental decorations, lights, reflectors, etc.). In some embodiments, the stop member 130 also includes an access channel 336 defined between a first portion 337a of the stop member 130 and a second portion 337b of the stop member 130 adjacent to the first portion 337a. The access channel 336 permits the stop member 130 to be removably installed onto the lead line 110. Specifically, the stop member 130 can be coupled to/installed onto the first loop 114a of the lead line 110 by pressing an edge portion of the lead line 110 against the stop member 130 adjacent to the access channel 336 to deflect the portions 337a, b of the stop member 130 away from each other to allow the lead line 110 to pass through the access channel 336 into the first opening 332. The access channel 336 can be angled relative to the first opening 332 to (i) inhibit the lead line 110 from accidentally slipping out of the first opening 332 and (ii) permit the portions 337a, b of the stop member 130 to press against each other for support when the stop member 130 is under load (e.g., when the stop member 130 engages the connection member 120).

In one aspect of the present technology, the stop member 130 can be easily installed onto and removed from the lead line 110 to facilitate replacement of the stop member 130 and/or washing of the lead line 110. For example, the stop member 130 can be removed from the lead line 110 so that the lead line 110 can be washed in a washing machine without the risk of the stop member 130 damaging the washing machine. Moreover, with the stop member 130 removed from the lead line 110, the lead line 110 can be pulled entirely through the connection member 120 (FIG. 1)—advantageously allowing the entire leash assembly 100 to be disassembled. In other embodiments, the stop member 130 does not include the access channel 336 and is instead installed on the lead line 110 during, for example, formation of the first loop 114a. That is, for example, the lead line 110 can be threaded through the first opening 332 before attaching the lead line 110 to itself to form the first loop 114a. Accordingly, in some embodiments the stop member 130 can be non-removably (e.g., permanently) coupled to the lead line 110.

As described in detail above, in some embodiments the stop member 130 is free to slide around a length of the first loop 114a and/or the second loop 114b when the stop member 130 is installed thereon. Therefore, when the handler holds the first loop 114a and/or the second loop 114b above the animal, the stop member 130 can move (e.g., in a direction indicated by either arrow B or arrow C in FIG. 4) toward and rest near the first connection region 111a or the second connection region 111b of the lead line 110 out of the way of the handler's hand.

In some embodiments, the second opening 334 can provide an attachment point for optional accessories. For example, a leather thong or other grip member (not shown) can be attached to the stop member 130 via the second opening 334 (e.g., via a clip or other fastener). Such a grip member can make it easier for the handler to pull the stop member 130 away from the connection member 120 (FIG. 1) for moving the lead line 110 to a different position, as shown in FIGS. 2A-2C. In general, a wide variety of ornamental and/or functional accessories (e.g., bells, tags, etc.) can be coupled to the stop member 130 via the second opening 334.

In the illustrated embodiment, the stop member 130 has a flat profile with a generally rectilinear or domed profile shape having rounded corners (e.g., to minimize sharp points/corners that may damage the lead line 110 and/or potentially harm the animal and/or the handler). In some embodiments, the stop member 130 can have a width W of about 1.50 inches and a length L of about 1.0 inch. In a particular embodiment, the first opening 332 has a width of about 1.2 inches and length of about 0.1 inch, and the second opening 334 has a width of about 0.5 inch and a length of about 0.38 inch. However, in other embodiments the stop member 130 and the slots 332, 334 can have other suitable dimensions and shapes. For example, the shape and size of the slots 332, 334 can be selected based on the size and shape of the lead line 110, the connection member 120, and/or any optional accessories to be fastened to the stop member 130. The stop member 130 can be manufactured from metal (e.g., aluminum, spring steel), plastic, nylon, and/or other materials strong enough to withstand the force of an animal pulling on the leash assembly 100. Likewise, a thickness T of the stop member 130 can be selected to provide a desired strength.

In other embodiments, the stop member 130 can have other suitable shapes/configurations. For example, the stop member 130 could comprise a snap hook, a carabiner, a metal D-ring, a knot tied in the lead line 110, etc. More generally, as described in detail above, the stop member 130 can be any component sized and shaped such that it cannot pass through the opening 122 of the connection member 120 (FIG. 1).

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment.

Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples: alternative implementations may employ differing values or ranges.

While the above description describes various embodiments of the invention and the best mode contemplated, regardless how detailed the above text, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/We claim:

1. An animal leash assembly, comprising:
a connection member having an opening, wherein the connection member is configured to be coupled to an animal restraint;
a lead line slidably positioned within the opening of the connection member, wherein the lead line includes a first end region and a second end region on opposite sides of the connection member;
a first stop portion at the first end region of the lead line, wherein the first stop portion is configured to prevent the first end region of the lead line from sliding entirely through the opening of the connection member; and
a second stop portion at the second end region of the lead line, wherein the second stop portion is configured to prevent the second end region of the lead line from sliding entirely through the opening of the connection member.

2. The leash assembly of claim 1 wherein the first stop portion is removably coupled to the first end region of the lead line, and wherein the second stop portion is removably coupled to the second end region of the lead line.

3. The leash assembly of claim 1 wherein the lead line includes a first loop configured for manual grasping at the first end region and a second loop configured for manual grasping at the second end region.

4. The leash assembly of claim 3 wherein the first loop and the second loop are sized to slide entirely through the opening.

5. The leash assembly of claim 3 wherein the first stop portion is slidably coupled to the first loop, and wherein the second stop portion is slidably coupled to the second loop.

6. The leash assembly of claim 3 wherein a portion of the first loop forms the first stop portion, and wherein a portion of the second loop forms the second stop portion.

7. The leash assembly of claim 1 wherein the opening has a maximum cross-sectional dimension, wherein the first stop portion has at least one dimension greater than the maximum cross-sectional dimension of the opening, and wherein the second stop portion has at least one dimension greater than the maximum cross-sectional dimension of the opening.

8. The leash assembly of claim 1 wherein the first stop portion and the second stop portion each comprise a D-ring.

9. The leash assembly of claim 1, further comprising:
a first handle coupled to the first end region of the lead line; and
a second handle coupled to the second end region of the lead line.

10. The leash assembly of claim 1 wherein the first stop portion is non-removably coupled to the first end region of the lead line, and wherein the second stop portion is non-removably coupled to the second end region of the lead line.

11. A leash assembly, comprising:
a connection member configured to be coupled to an animal restraint; and
a lead line slidably coupled to the connection member, wherein the lead line includes a first end region and a second end region, wherein the lead line is movable from (a) a first position in which the first end region is positioned proximate to the connection member to (b) a second position in which the second end region is positioned proximate to the connection member.

12. The leash assembly of claim 11 wherein the first end region of the lead line includes a first stop portion configured to prevent the first end region of the lead line from sliding entirely through the connection member, and wherein the second end region of the lead line includes a second stop portion configured to prevent the second end region of the lead line from sliding entirely through the connection member.

13. The leash assembly of claim 11 wherein the lead line is attached to itself to form (a) a first loop at the first end region and (b) a second loop at the second end region, wherein the first loop is configured to be grasped by a handler in the first position, and wherein the second loop is configured to be grasped by the handler in the second position.

14. The leash assembly of claim 13, further comprising:
a first stop member slidably coupled to the first loop of the lead line, wherein the first stop member is sized and shaped to prevent the first loop from sliding entirely through the connection member, and
a second stop member slidably coupled to the second loop of the lead line, wherein the second stop member is sized and shaped to prevent the second loop from sliding entirely through the connection member.

15. The leash assembly of claim 14 wherein the first stop member abuts the connection member in the first position, and wherein the second stop member abuts the connection member in the second position.

16. The leash assembly of claim 14 wherein the first stop member comprises a first D-ring, wherein the second stop member comprises a second D-ring, wherein the first D-ring includes a first slot configured to slidably receive a portion of the first loop, and wherein the second D-ring includes a second slot configured to slidably receive a portion of the second loop.

17. The leash assembly of claim 11 wherein—
in the first position, the first end region of the lead line is positioned at least partially within the connection member, and
in the second position, the second end region of the lead line is positioned at least partially within the connection member.

18. A leash assembly, comprising:
a lead line having a first end region and a second end region, wherein the first and second end regions are configured to be grasped by a user;
coupling means for coupling the lead line to an animal restraint, wherein the lead line is slidably coupled to the coupling means;
first stop means for preventing the first end region of the lead line from disengaging the coupling means; and
second stop means for preventing the second end region of the lead line from disengaging the coupling means.

19. The leash assembly of claim 18 wherein preventing the first end region of the lead line from disengaging the coupling means includes preventing the first end region of the lead line from disengaging the coupling means when the second end region of the lead line is pulled away from the coupling means, and wherein preventing the second end region of the lead line from disengaging the coupling means includes preventing the second end region of the lead line from disengaging the coupling means when the first end region of the lead line is pulled away from the coupling means.

20. The leash assembly of claim 18 wherein the animal restraint is an animal harness or animal collar.
